(19) United States
(12) Patent Application Publication
(10) Pub. No.: US 2026/0037865 A1
(43) Pub. Date: Feb. 5, 2026

(54) ENHANCED TECHNIQUES FOR TRAINING LARGE LANGUAGE MODELS USING TABLE DATA

(71) Applicant: Microsoft Technology Licensing, LLC, Redmond, WA (US)

(72) Inventors: Yeye HE, Redmond, WA (US); Surajit CHAUDHURI, Kirkland, WA (US); Dongmei ZHANG, Beijing (CN); Shi HAN, Beijing (CN); Haoyu DONG, Beijing (CN); Mengyu ZHOU, Beijing (CN); Junjie XING, Redmond, WA (US)

(21) Appl. No.: 18/990,904

(22) Filed: Dec. 20, 2024

Related U.S. Application Data
(60) Provisional application No. 63/679,050, filed on Aug. 2, 2024.

(51) Int. Cl. G06N 20/00; G06F 40/226; G06F 40/30

(52) U.S. Cl. CPC G06N 20/00; G06F 40/226; G06F 40/30

(57) ABSTRACT

The disclosed techniques pertain to training large language models (“LLMs”) using table data. Specifically, the disclosed techniques pertain to training LLMs for table-related tasks using two models, each model reserved for different functions. A first model is reserved for generator functions and a second model is reserved for validator functions. The first model receives table data and generates training data. The training data is fed to the second model, which identifies instances of training data meeting or exceeding at least one validity threshold. Instances of training data meeting or exceeding the at least one validity threshold are output as validated training data. The validated training data is used to iteratively fine-tune the two models by increasing or decreasing one or more numeric weight parameters in each of the models that control how the models process input data and produce outputs.

### CROSS-REFERENCE TO RELATED APPLICATION

This application claims the benefit of U.S. provisional application No. 63/679,050 filed on Aug. 2, 2024, entitled “ENHANCED TECHNIQUES FOR TRAINING LARGE LANGUAGE MODELS USING TABLE DATA” the entirety of which is hereby incorporated by reference herein.

### BACKGROUND

There are a number of companies developing systems that use language models to help users perform all kinds of tasks in productivity applications such as Word, Excel, PowerPoint, etc. Many early approaches to this work have been based on prompting Generative Pre-trained Transformer models (“GPTs”) and writing instructions for GPTs to follow.

Unlike other applications that rely on traditional natural language structure, spreadsheet users primarily work on tables, which are quite different from natural language documents and present unique challenges for GPT language models. GPTs are typically trained on natural language text, such as text documents that are crawled from the web. As such, these types of models are not good in terms of understanding data tables, which are two dimensional. Unlike natural language text that is typically read in one direction, tables have rows and columns that can be read up and down in addition to left and right. The result of this unique property of tables is GPT language models typically do not perform well in many table-related tasks.

### SUMMARY

The disclosed techniques pertain to a system and method for fine-tuning (“training”) large language models (“LLMs”) using table data. More specifically, the disclosed techniques pertain to a way of training LLMs for table-related tasks using two different models, with each model reserved for different functions. In some embodiments, a system includes a first model (“generator”) reserved for generator functions, such as generative tasks, and a second model (“validator”) reserved for validator functions, such as classification tasks. The generator functions of the first model are related to sampling table data, such as from real tables sampled from a corpus of tables, and generating training data based on the table data. The generated training data includes the table data and supplemental data produced by the generator, such as modifications and/or additions to the rows and columns of the table data. The validator functions of the second model are related to validating the training data generated by the first model to produce a subset of the generated training data, which contains only high-quality training data. The high-quality training data (“validated training data”) is then used to iteratively fine-tune the two models by increasing or decreasing one or more numeric weight parameters in each of the models that control how the models process input data and produce outputs.

In some embodiments, a first iteration of training begins when the first model receives real tables, sampled from a corpus of tables, comprising instances of table data. The first model runs code to perform at least one generator function and generate training data based on the instances of table data. The generated training data comprises both the instances of table data and corresponding instances of supplemental data that characterize modifications and/or additions to the rows and columns of the table data produced by the generator function. Next, the generated training data is fed to the second model, which receives the generated training data and performs at least one validator function to evaluate the generated training data and produce interim data by determining which instances of supplemental data meet or exceed at least one validity threshold. The interim data comprises a first subset of the supplemental data and a second subset of the supplemental data. The first subset comprises the instances of supplemental data that meet or exceed at least one validity threshold. The second subset comprises the instances of supplemental data that do not meet or exceed the at least one validity threshold. The first subset of the interim data, having the instances of supplemental data that meet or exceed the at least one validity threshold, is selected by the second model as validated training data. Once the second model has selected a threshold number of instances of validated training data, the validated training data is used to iteratively fine-tune the first model and the second model. Iteratively fine-tuning the first model comprises increasing or decreasing one or more weight parameters of the first model that determine how the first model processes the table data and produces the generated training data. Iteratively fine-tuning the second model comprises increasing or decreasing one or more weight parameters of the second model that determine how the second model processes the generated training data and produces the validated training data. Specifically, the system compares the generated training data to the validated training data to compute at least one loss value for the first model, quantifying at least one error metric between the generated training data and the validated training data, such as a number of mismatched tokens in a generated piece of code, a count of incorrect modifications in a table, or a discrepancy in numerical values. The system then compares the second model's evaluation of the generated training data, using the interim data, to ground truth labels, which may be derived from predefined validation criteria or the validated training data, to compute at least one loss value for the second model, quantifying at least one error metric between the interim data and the ground truth labels, such as a number of misclassified errors in a table, a count of false positives and false negatives in entity matching, or the accuracy of determining whether a generated piece of code meets predefined validation criteria. Through gradient descent, each model iteratively adjusts one or more weight parameters during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

Each subsequent iteration of training repeats the operations of the first iteration using subsequent instances of table data sampled from the table corpus. Subsequent instances of table data differ from instances of table data that were sampled from the table corpus in previous iterations of training. The subsequent instances of table data are used as an input to the first model for generating a subsequent iteration of generated training data. The subsequent iteration of generated training data is used as an input to the second model, and in each subsequent iteration of training, the second model produces a subsequent iteration of validated training data that is used to iteratively increase or decrease the one or more weight parameters of the first model and the one or more weight parameters of the second model. Each iteration of training produces a nth iteration of validated training data that is used to increase the accuracy and efficiency of the models and improve their performance on table-related tasks, thereby producing a trained first model and a trained second model.

The techniques disclosed herein provide a number of technical benefits including configuring an artificial intelligence system that is able to effectively process table data. By using a generator-validator process to iteratively fine-tune the two models based on table data, a system can simultaneously train specialized models to assist users in performing multiple types of table-related tasks, such as generative tasks and classification tasks. This generator-validator process not only overcomes the table-related shortcomings of traditional LLMs that are trained solely on natural language, but also increases the performance of the two models on table-related tasks, allowing for the deployment of smaller, more specialized models that are cheaper and more energy efficient versus larger LLMs that have been used for table-related tasks in the past.

Another technical benefit of the disclosed techniques is the two models of the generator-validator process are coordinated in such a way that they can leverage the permutation invariant properties of tables to more efficiently identify high-quality training data. By shuffling column values in the generated training data, the system can more accurately and efficiently identify high-quality training data, which, in turn, can be used to increase the accuracy and efficiency of the two models on table-related tasks.

Additionally, the disclosed techniques introduce a practical application that makes training machine learning models for table-related tasks more efficient. Specifically, traditional training methods for a validator model require a user to review raw table data and create training examples to be fed into the validator as training data. Similarly, traditional training methods for a generator model require a user to review training data that is output from the generator model and manually select, or “validate,” examples to be fed back into the generator as validated training data. The iterative fine-tuning process disclosed herein allows the generator and validator models to automatically, and continuously, use real tables to generate training data and validate the quality of that training data, thereby identifying examples of high-quality training data and updating one or more weight parameters of each model without the need for any action by a user of the system. With each iteration, the models in the disclosed generator-validator process use at least one validity threshold to determine which examples of training data are suitable for the next iteration of fine-tuning and which examples are substandard and should be discarded.

Furthermore, the disclosed techniques also provide the benefit of increasing system security, as the increased efficiency of the generator-validator framework in validating model training data improves the security performance of the models on table-related tasks. For example, LLMs can significantly enhance system security through validation techniques, such as vulnerability detection, threat prediction, automated code review, and incident response. For vulnerability detection, LLMs can analyze code related to tables and identify potential vulnerabilities by understanding the context and semantics of the code, which traditional methods might miss. For threat prediction, LLMs can analyze data patterns and predict potential threats and attacks before they happen, allowing for proactive security measures related to table data. For automated code review, LLMs can automatically review code for security issues, such as during the NL2SQL process, described in detail below, ensuring that best practices are followed and reducing the risk of human error. For incident response, LLMs can assist by quickly analyzing a table-related system breach and suggesting appropriate responses.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a system diagram showing an overview of the system before the iterative fine-tuning process, where the first model (“generator”) and the second model (“validator”) are untrained (“vanilla”) LLMs.

FIG. 2A is a system diagram showing the generator receiving an initial input of table data and performing a generator function to produce generated training data comprising the table data and supplemental data.

FIG. 2B is a system diagram showing the generator model outputting generated training data to the validator model.

FIG. 2C is a system diagram showing the validator model receiving generated training data and performing part of a validator function to produce interim data comprising a first subset of the generated training data and a second subset of the generated training data.

FIG. 2D is a system diagram showing the validator performing part of a validator function by selecting the first subset of the interim data as validated training data.

FIG. 2E is a system diagram showing the validator outputting validated training data, which is then used to fine-tune the two models by adjusting one or more numeric weight parameters of the two models.

FIG. 2F is a system diagram showing validated training data being used to adjust weight parameters of the two models via error metrics and loss values.

FIG. 2G is a system diagram showing an overview of the iterative fine-tuning process using the task of error detection as a specific example of how the models process table data and produce validated training data for use in adjusting one or more weight parameters of the models.

FIG. 3 is a system diagram showing the generator model and the validator model as trained large language models, where an nth iteration of fine-tuning produces an nth iteration of generated training data and nth iteration of validated training data.

FIG. 4 is a taxonomy table describing the different generative tasks and classification tasks for which the generator model and the validator model may be trained using iterative fine-tuning.

FIG. 5 is a system diagram showing aspects of the Natural Language to SQL (“NL2SQL”) task, where the generated training data comprises an instance of table data, a natural language prompt, and at least two pieces of code written in different languages. The two pieces of code are executed on top of the table by the validator.

FIG. 6 is a flow diagram showing aspects of a routine for using table data and iterative fine-tuning to train large language models.

FIG. 7 is a computer architecture diagram showing an illustrative architecture for a computer that can implement the technologies disclosed herein.

### DETAILED DESCRIPTION

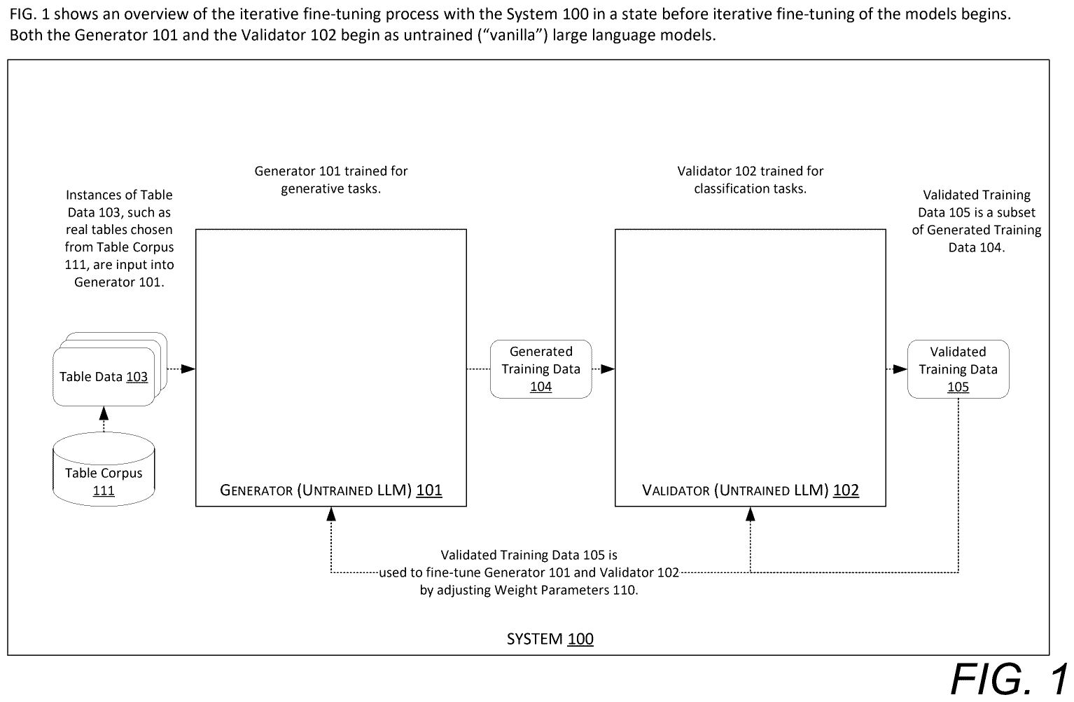

FIGS. 1-3 show a system for training large language models (“LLMs”) using table data. More specifically, FIGS. 1-3 show a system for training LLMs for table-related tasks using two different models, with each model reserved for different functions. In some embodiments, the system includes a first generator model (“generator”) reserved for generator functions, such as generative tasks, and a second validator model (“validator”) reserved for validator functions, such as classification tasks. The generator functions of the first model are related to sampling instances of table data, such as from real tables sampled from a corpus of tables, and generating training data based on the instances of table data. The validator functions of the second model are related to evaluating and validating the generated training data produced by the first model. The validated training data output by the second model is used to iteratively fine-tune the two models by increasing or decreasing one or more numeric weight parameters in each of the models that control how the models process input data and produce output data. Specifically, the system compares the generated training data to the validated training data to compute at least one loss value for the first model, quantifying at least one error metric between the generated training data and the validated training data, such as a number of mismatched tokens in a generated piece of code, a count of incorrect modifications in a table, or a discrepancy in numerical values. The system then compares the second model's evaluation of the generated training data, using the interim data, to ground truth labels, which may be derived from predefined validation criteria or the validated training data, to compute at least one loss value for the second model, quantifying at least one error metric between the interim data and the ground truth labels, such as a number of misclassified errors in a table, a count of false positives and false negatives in entity matching, or the accuracy of determining whether a generated piece of code meets predefined validation criteria. Through gradient descent, each model iteratively adjusts one or more weight parameters during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

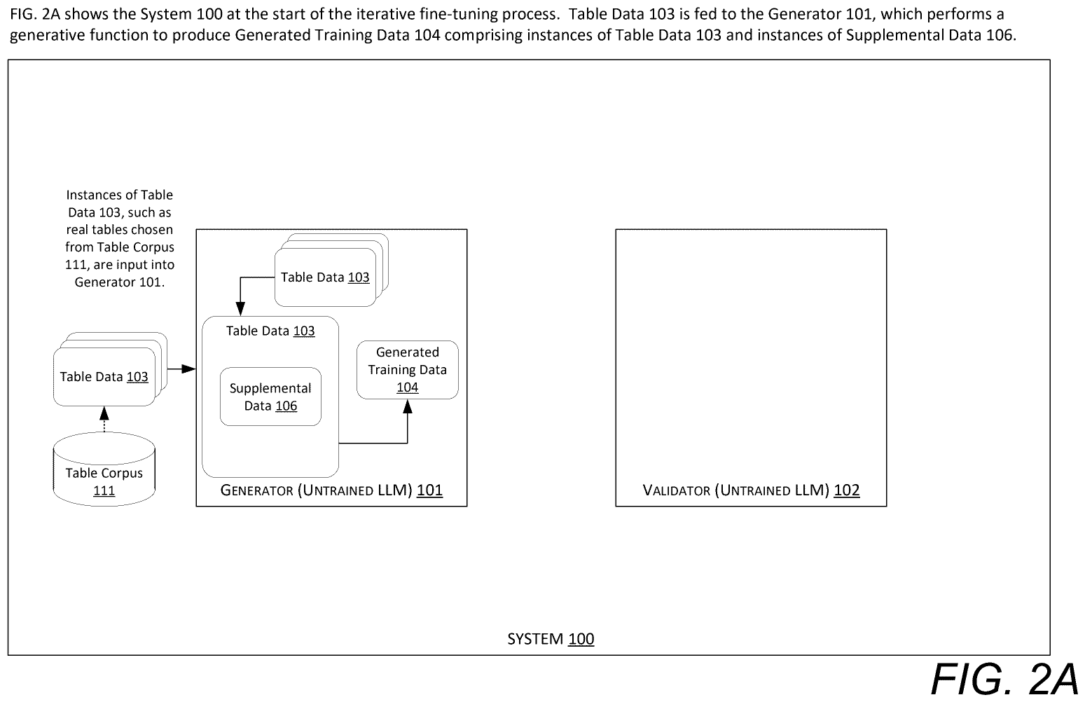

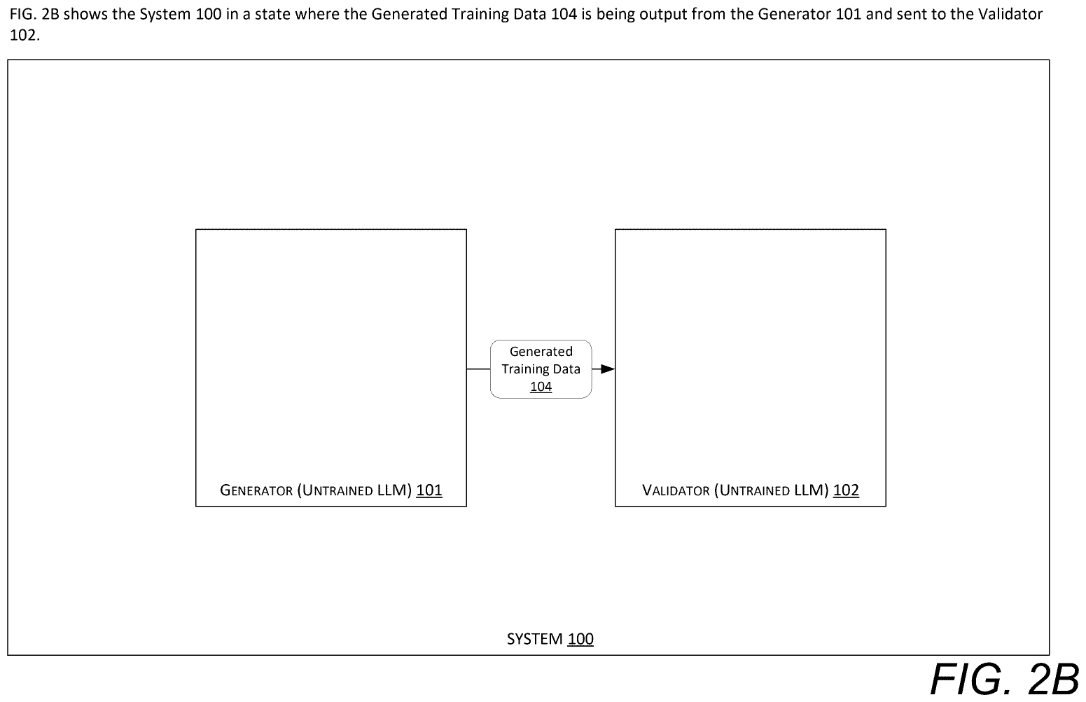

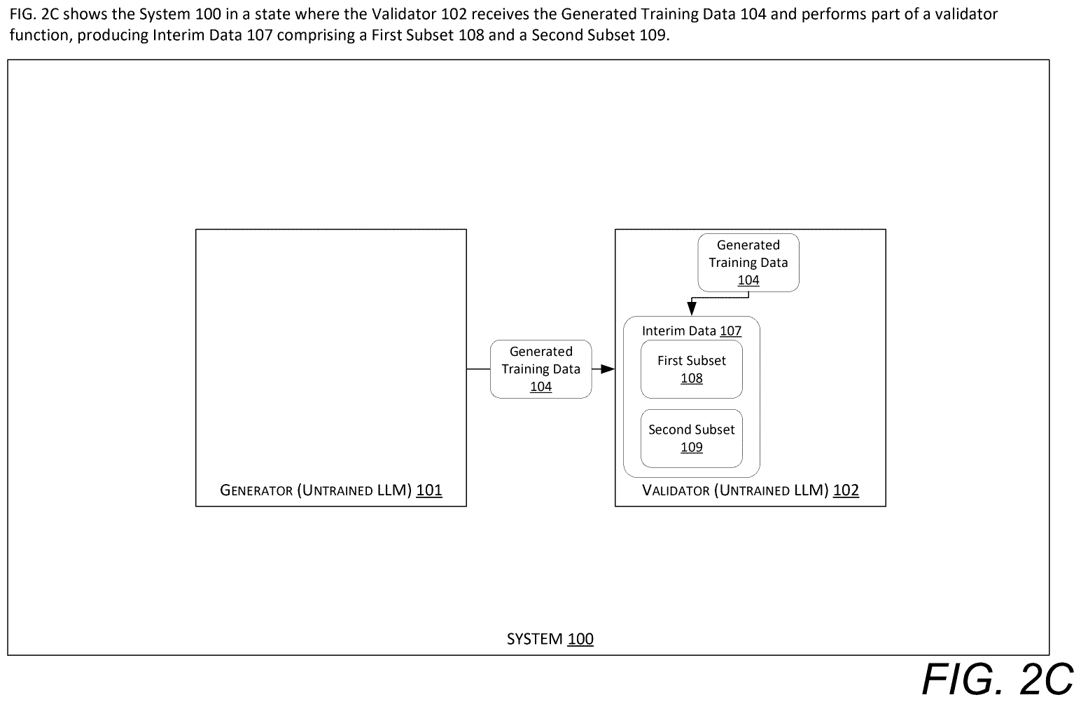

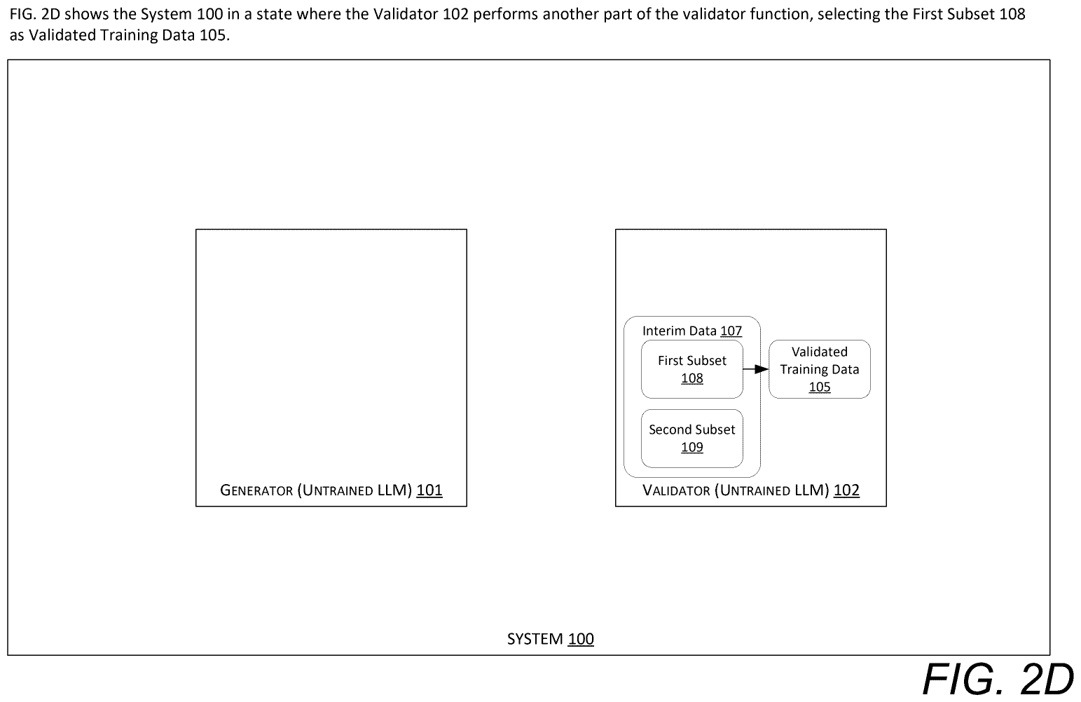

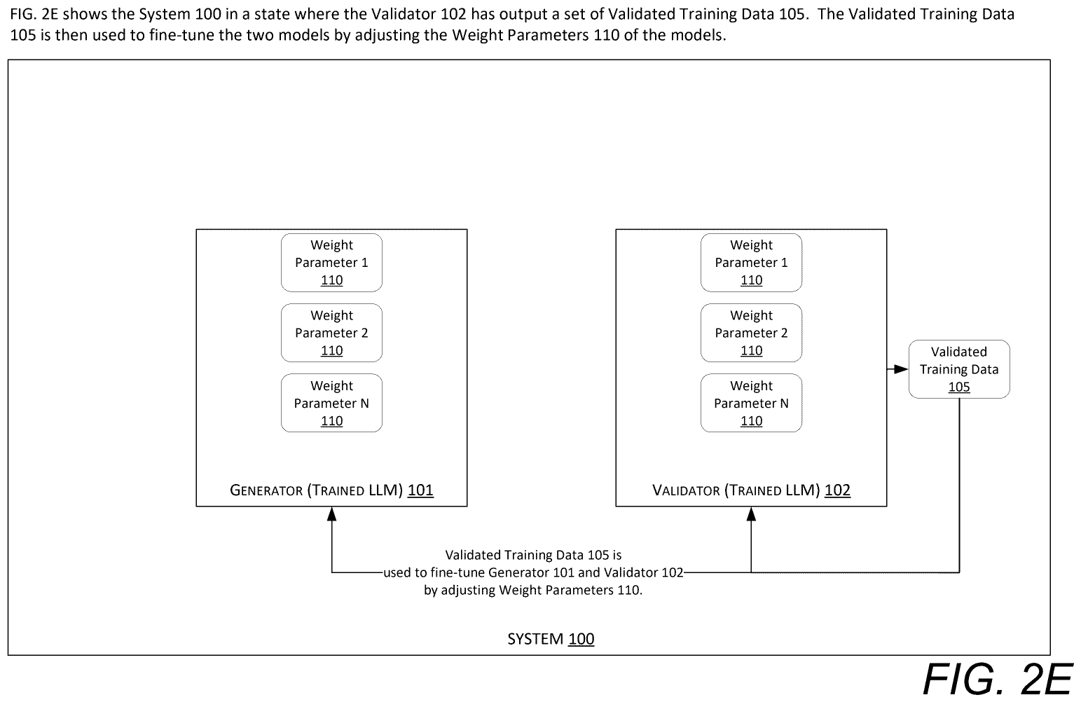

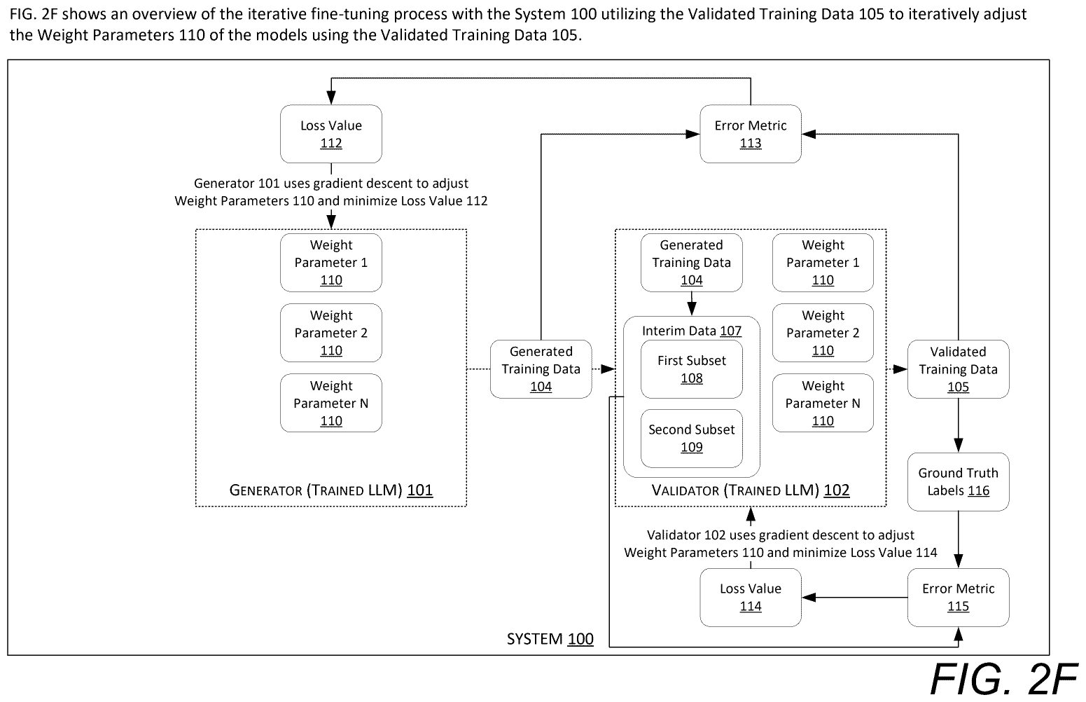

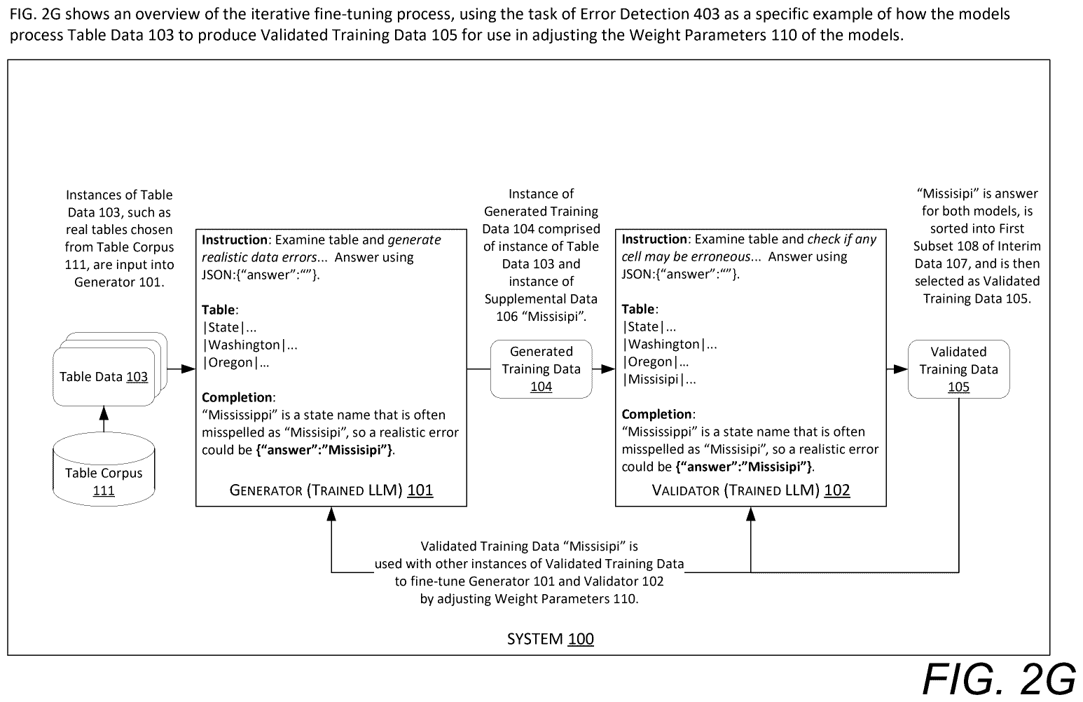

FIG. 1 shows an overview of the iterative fine-tuning process with the generator 101 and the validator 102 beginning as untrained (“vanilla”) LLMs. As shown in FIG. 2A, a first iteration of training begins when the generator 101 receives an initial input of instances of table data 103, such as real tables sampled from a corpus of tables 111, and, in response, runs code to perform at least one generator function to produce generated training data 104 based on the instances of table data 103. The generated training data 104 comprises both the instances of table data 103 and corresponding instances of supplemental data 106 that characterize modifications and/or additions to the rows and columns of the table data 103 produced by the generator function. Next, as shown in FIG. 2B, the generated training data 104 is output from the generator 101 and fed to the validator 102. In response, as shown in FIG. 2C, the validator 102 receives the generated training data 104 and performs at least one validator function to evaluate the generated training data and produce interim data 107 by determining which instances of supplemental data 106 meet or exceed at least one validity threshold e.g., instances of supplemental data 106 having a quality value meeting or exceeding at least one validity threshold. The interim data 107 comprises a first subset 108 of the instances of supplemental data 106 and a second subset 109 of the instances of supplemental data 106. The first subset 108 comprises instances of supplemental data 106 that meet or exceed at least one validity threshold. The second subset 109 comprises instances of supplemental data 106 that do not meet or exceed the at least one validity threshold. As shown in FIG. 2D, the first subset 108 of the interim data 107, having the instances of supplemental data 106 that meet or exceed the at least one validity threshold, is selected by the validator 102 as validated training data 105. As shown in FIG. 2E, once the validator 102 has selected a threshold number of instances of validated training data 105, the validated training data 105 is output and used to iteratively fine-tune the first model 101 and the second model 102. Iteratively fine-tuning the first model 101 comprises increasing or decreasing one or more weight parameters 110 of the first model 101 that determine how the first model 101 processes the table data 103 and produces the generated training data 104. Iteratively fine-tuning the second model 102 comprises increasing or decreasing one or more weight parameters 110 of the second model 102 that determine how the second model 102 processes the generated training data 104 and produces the validated training data 105. Specifically, as shown in FIG. 2F, the system 100 compares the generated training data 104 to the validated training data 105 to compute at least one loss value 112 for the first model 101, quantifying at least one error metric 113 between the generated training data 104 and the validated training data 105, such as a number of mismatched tokens in a generated piece of code, a count of incorrect modifications in a table, or a discrepancy in numerical values. The system 100 then compares the second model's evaluation of the generated training data 104, using the interim data 107, to ground truth labels 116, which may be derived from predefined validation criteria or the validated training data 105, to compute at least one loss value 114 for the second model 102, quantifying at least one error metric 115 between the interim data 107 and the ground truth labels 116, such as a number of misclassified errors in a table, a count of false positives and false negatives in entity matching, or the accuracy of determining whether a generated piece of code meets predefined validation criteria. Through gradient descent, each model iteratively adjusts one or more weight parameters 110 during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

In the embodiments disclosed herein, the generator 101 may, as an alternative to the techniques described above, sample one instance of table data 103 at a time and send one instance of generated training data 104 to the validator 102 at a time (i.e., generated training data 104 may comprise a single instance of table data 103 and a single corresponding instance of supplemental data 106). Similarly, the validator 102 may perform the validator function on one instance of generated training data 104 at a time and/or wait to select the first subset 108 as validated training data 105 until the first subset 108 meets or exceeds a threshold number of instances of supplemental data 106. Additionally, the embodiments disclosed herein may perform various combinations of the above described techniques for sampling instances of table data 103 and validating instances of supplemental data 106 as validated training data 105.

As shown in FIG. 2G, the models process table data 103 using the exemplary task of error detection 403, described in more detail below, to produce validated training data 105 for adjusting one or more weight parameters 110 of the models during fine-tuning. Specifically, the generator 101 samples an instance of table data 103 and performs a generator function to produce generated training data 104 by adding the erroneous value “Missisipi” to the table data 103 as supplemental data 106. The generated training data 104 is then sent to the validator model 102, which performs a validator function to try and identify the erroneous value. Upon successfully identifying “Missisipi” as an error, the supplemental data 106 is sorted into the first subset 108 of the interim data 107, which is then selected as validated training data 105. Once a threshold number of instances of validated training data 105 have been selected, the validated training data 105 is used to adjust the weight parameters 110 of the first model 101 and the second model 102 during iterative fine-tuning.

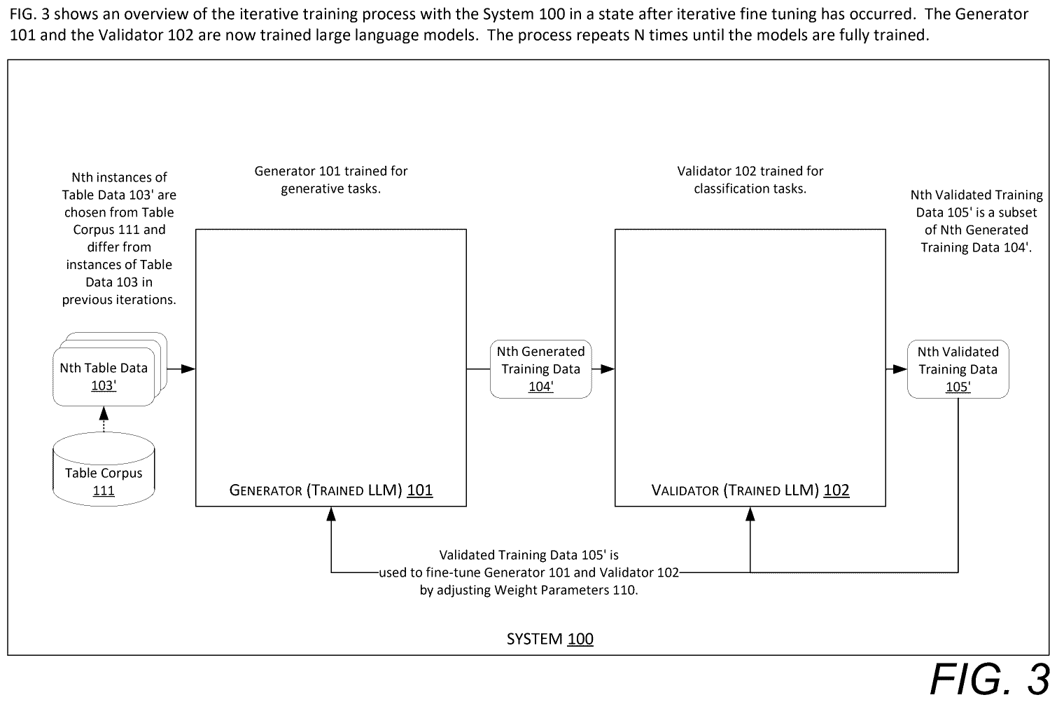

Once the models have been iteratively fine-tuned using the validated training data 105, one or more subsequent iterations of training begin. Each subsequent iteration of training repeats the operations of the first iteration using subsequent instances of table data 103′ sampled from the table corpus 111. Subsequent instances of table data 103′ differ from instances of table data 103 that were sampled from the table corpus 111 in previous iterations. The subsequent instances of table data 103′ are used as an input to the first model 101 for generating a subsequent iteration of generated training data 104′. The subsequent iteration of generated training data 104′ is used as an input to the second model 102. In each subsequent iteration, the second model 102 produces a subsequent iteration of validated training data 105′ that is used to iteratively increase or decrease one or more weight parameters 110 of the first model 101 and one or more weight parameters 110 of the second model 102. As shown in FIG. 3, each iteration of training produces a nth iteration of validated training data 105′ that is used to increase the accuracy and efficiency of the models and improve their performance on table-related tasks, thereby producing a trained first model 101 and a trained second model 102.

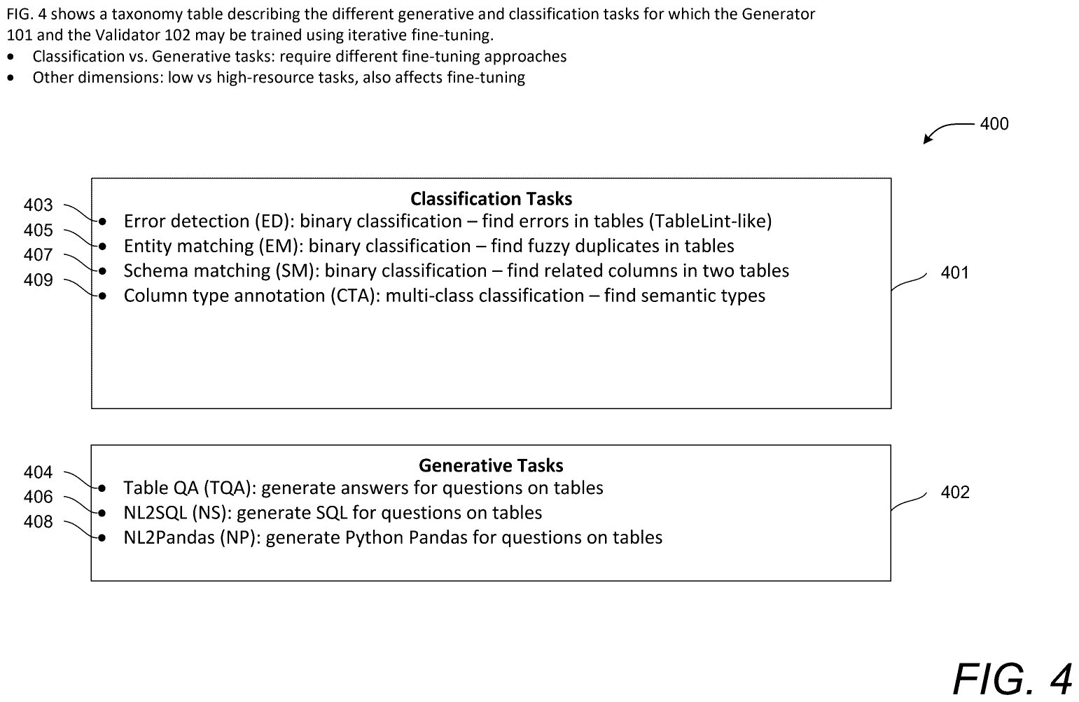

FIG. 4 shows a taxonomy 400 of classification tasks 401 and generative tasks 402 for which the system 100 described herein can train models using iterative fine-tuning. In some embodiments, the system 100 may train the models for table-related classification tasks 401. Classification tasks 401 are a type of machine learning task where a large amount of information is provided, and the goal is for a model to perform a task such as predicting “true” or “false” or selecting from among a few options, such as A, B, C, and D.

In one embodiment, the system 100 can be configured to train models for the classification task of error detection 403. The goal of an error detection model is to find data quality errors in a user's spreadsheet table. For example, if a table has a column of countries, and, for a couple of the cells in the same column, a user has entered city names or peoples' names, which are not compatible with other country names in the same column, the goal is for a model to be able to flag those issues and prompt a user to correct them.

To train the models for the classification task of error detection 403, the system 100 uses the generator-validator framework shown in FIGS. 1-3 to concurrently train both a generator 101 for generating training data 104 and a validator 102 for validating the generated training data 104. The system 100 begins a first iteration of training by feeding instances of table data 103 that are sampled from a corpus of tables 111 into the generator 101, which begins as an untrained language model, such as GPT 3 or GPT 4. In response to receiving the instances of table data 103, the generator 101 performs at least one generator function to produce generated training data 104 for the task of error detection 403. The generated training data 104 comprises both the instances of table data 103 and corresponding instances of supplemental data 106 that characterize modifications and/or additions to the rows and columns of the table data 103 produced by the generator function. Specifically, the generator 101 produces generated training data 104 by sampling each instance of table data 103 and generating a corresponding instance of supplemental data 106 comprising an outlier for at least one row or column in each instance of table data 103, such as a typo or some other value that is semantically incompatible with the rest of the values in that row or column. The generator 101 then leverages the permutation invariant properties of tables and randomly perturbs the values in any row or column with an outlier, creating permutations with the outlier in different positions in the row or column.

Next, the generated training data 104 is fed to the validator 102, which also begins as an untrained language model. In response to receiving the generated training data 104, the validator 102 performs at least one validation function to sample the generated training data 104 and attempt to identify any outliers produced by the generator 101 as supplemental data 106. Specifically, the validator 102 performs at least one validation function to produce interim data 107 and determine which instances of supplemental data 106 meet or exceed at least one validity threshold. The interim data 107 comprises a first subset 108 of the supplemental data 106 and a second subset 109 of the supplemental data 106. The first subset 108 comprises the instances of supplemental data 106 that meet or exceed at least one validity threshold. The second subset 109 comprises the instances of supplemental data 106 that do not meet or exceed the at least one validity threshold. If the validator 102 determines an instance of supplemental data 106 meets or exceeds at least one validity threshold by successfully identifying the outlier in one or more permutations, the instance of supplemental data 106 is added to the first subset 108 of the interim data 107. Once a threshold number of instances of supplemental data 106 is reached, the validator 102 selects the first subset 108 of the interim data 107 as validated training data 105 for the task of error detection 403. Once a threshold number of instances of validated training data 105 are selected, the validated training data 105 is used to iteratively fine-tune the generator 101 and the validator102. Iteratively fine-tuning the generator 101 comprises increasing or decreasing one or more weight parameters 110 of the generator 101 that determine how the generator 101 processes the table data 103 and produces the generated training data 104. Iteratively fine-tuning the validator 102 comprises increasing or decreasing one or more weight parameters 110 of the validator 102 that determine how the validator 102 processes the generated training data 104 and produces the validated training data 105. Specifically, the system 100 compares the generated training data 104 to the validated training data 105 to compute at least one loss value 112 for the generator 101, quantifying at least one error metric 113 between the generated training data 104 and the validated training data 105, such as a number of mismatched tokens in a generated piece of code, a count of incorrect modifications in a table, or a discrepancy in numerical values. The system 100 then compares the validator's evaluation of the generated training data 104, using the interim data 107, to ground truth labels 116, which may be derived from predefined validation criteria or the validated training data 105, to compute at least one loss value 114 for the validator 102, quantifying at least one error metric 115 between the interim data 107 and the ground truth labels 116, such as a number of misclassified errors in a table, a count of false positives and false negatives in entity matching, or the accuracy of determining whether a generated piece of code meets predefined validation criteria. Through gradient descent, each model iteratively adjusts one or more weight parameters 110 during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

Each subsequent iteration of training repeats the operations of the first iteration using subsequent instances of table data 103′ sampled from the table corpus 111. Subsequent instances of table data 103′ differ from instances of table data 103 that were sampled from the table corpus 111 in previous iterations. The subsequent instances of table data 103′ are used as an input to the first model 101 for generating a subsequent iteration of generated training data 104′. The subsequent iteration of generated training data 104′ is used as an input to the second model 102 for generating a subsequent iteration of validated training data 105′. Each subsequent iteration of validated training data 105′ is used to iteratively increase or decrease one or more weight parameters 110 of the first model 101 and one or more weight parameters 110 of the second model 102. Each iteration of training produces a nth iteration of validated training data 105′ that is used to increase the accuracy and efficiency of the models and improve their performance on the task of error detection 403, thereby producing a trained first model 101 and a trained second model 102.

In another embodiment, the system 100 can be configured to train models for the classification task of entity matching 405. The goal for an entity matching model is to be able to sample rows and columns, either across tables or within the same table, and detect fuzzy duplicates. For example, a fuzzy duplicate (or “fuzzy match”) is when the same value, such as a person's name or an address, is mentioned in slightly different ways due to spelling variations, typos, or syntactic differences.

To train the models for the classification task of entity matching 405, the system 100 uses the generator-validator framework shown in FIGS. 1-3 to concurrently train both a generator 101 for generating training data 104 and a validator 102 for validating the generated training data 104. The system 100 begins a first iteration of training by feeding instances of table data 103 that are sampled from a corpus of tables 111 into the generator 101, which begins as an untrained language model, such as GPT 3 or GPT 4. In response to receiving the instances of table data 103, the generator 101 performs at least one generator function to produce generated training data 104 for the task of entity matching 405. The generated training data 104 comprises both the instances of table data 103 and corresponding instances of supplemental data 106 that characterize modifications and/or additions to the rows and columns of the table data 103 produced by the generator function. Specifically, the generator 101 produces generated training data 104 by sampling each instance of table data 103 and generating a corresponding instance of supplemental data 106 comprising an outlier for at least one row or column in each instance of table data 103, such as a fuzzy duplicate of an entry in a row or column. The generator 101 then leverages the permutation invariant properties of tables and randomly perturbs the values in any row or column with outliers, creating permutations with the outlier in different positions in the row or column.

Next, the generated training data 104 is fed to the validator 102, which also begins as an untrained language model. In response to receiving the generated training data 104, the validator 102 performs at least one validation function to sample the generated training data 104, attempt to identify any outliers produced by the generator 101 as supplemental data 106, and consolidate and/or deduplicate the fuzzy duplicate entries to provide the user with a cleaner table. Specifically, the validator 102 performs at least one validation function to produce interim data 107 and determine which instances of supplemental data 106 meet or exceed at least one validity threshold. The interim data 107 comprises a first subset 108 of the supplemental data 106 and a second subset 109 of the supplemental data 106. The first subset 108 comprises the instances of supplemental data 106 that meet or exceed at least one validity threshold. The second subset 109 comprises the instances of supplemental data 106 that do not meet or exceed the at least one validity threshold. If the validator 102 determines an instance of supplemental data 106 meets or exceeds at least one validity threshold by successfully identifying the outlier in one or more permutations, the instance of supplemental data 106 is added to the first subset 108 of the interim data 107. Once a threshold number of instances of supplemental data 106 is reached, the validator 102 selects the first subset 108 of the interim data 107 as validated training data 105 for the task of entity matching 405. Once a threshold number of instances of validated training data 105 are selected, the validated training data 105 is used to iteratively fine-tune the generator 101 and the validator 102. Iteratively fine-tuning the generator 101 comprises increasing or decreasing one or more weight parameters 110 of the generator 101 that determine how the generator 101 processes the table data 103 and produces the generated training data 104. Iteratively fine-tuning the validator 102 comprises increasing or decreasing one or more weight parameters 110 of the validator 102 that determine how the validator 102 processes the generated training data 104 and produces the validated training data 105. Specifically, the system 100 compares the generated training data 104 to the validated training data 105 to compute at least one loss value 112 for the generator 101, quantifying at least one error metric 113 between the generated training data 104 and the validated training data 105, such as a number of mismatched tokens in a generated piece of code, a count of incorrect modifications in a table, or a discrepancy in numerical values. The system 100 then compares the validator's evaluation of the generated training data 104, using the interim data 107, to ground truth labels 116, which may be derived from predefined validation criteria or the validated training data 105, to compute at least one loss value 114 for the validator 102, quantifying at least one error metric 115 between the interim data 107 and the ground truth labels 116, such as a number of misclassified errors in a table, a count of false positives and false negatives in entity matching, or the accuracy of determining whether a generated piece of code meets predefined validation criteria. Through gradient descent, each model iteratively adjusts one or more weight parameters 110 during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

Each subsequent iteration of training repeats the operations of the first iteration using subsequent instances of table data 103′ sampled from the table corpus 111. Subsequent instances of table data 103′ differ from instances of table data 103 that were sampled from the table corpus 111 in previous iterations. The subsequent instances of table data 103′ are used as an input to the first model 101 for generating a subsequent iteration of generated training data 104′. The subsequent iteration of generated training data 104′ is used as an input to the second model 102 for generating a subsequent iteration of validated training data 105′. Each subsequent iteration of validated training data 105′ is used to iteratively increase or decrease one or more weight parameters 110 of the first model 101 and one or more weight parameters 110 of the second model 102. Each iteration of training produces a nth iteration of validated training data 105′ that is used to increase the accuracy and efficiency of the models and improve their performance on the task of entity matching 405, thereby producing a trained first model 101 and a trained second model 102.

In yet another embodiment, the system 100 can be configured to train models for the classification task of column type annotation (“CTA”) 409. The goal for a CTA model is to evaluate the content of a table and make a determination as to the semantic meanings of columns in the table. For example, a column header may say “name,” but if the model determines the data in the column looks like an address, it will tag that column accordingly, e.g., “mailing address in U.S.”

To train the models for the classification task of CTA 409, the system 100 uses the generator-validator framework shown in FIGS. 1-3 to concurrently train both a generator 101 for generating training data 104 and a validator 102 for validating the generated training data 104. The system 100 begins a first iteration of training by feeding instances of table data 103 that are sampled from a corpus of tables 111 into the generator 101, which begins as an untrained language model, such as GPT 3 or GPT 4. In response to receiving the instances of table data 103, the generator 101 performs at least one generator function to produce generated training data 104 for the task of CTA 409. The generated training data 104 comprises both the instances of table data 103 and corresponding instances of supplemental data 106 that characterize modifications and/or additions to the rows and columns of the table data 103 produced by the generator function. Specifically, the generator 101 produces generated training data 104 by sampling each instance of table data 103 and generating a corresponding instance of supplemental data 106 comprising an outlier for at least one row or column in each instance of table data 103, such as a column header that is semantically incompatible with the values in the column.

Next, the generated training data 104 is fed to the validator 102, which also begins as an untrained language model. In response to receiving the generated training data 104, the validator 102 performs at least one validation function to semantically analyze the generated training data 104 and attempt to identify any outliers produced by the generator 101 as supplemental data 106. Specifically, the validator 102 performs at least one validation function to produce interim data 107 and determine which instances of supplemental data 106 meet or exceed at least one validity threshold. The interim data 107 comprises a first subset 108 of the supplemental data 106 and a second subset 109 of the supplemental data 106. The first subset 108 comprises the instances of supplemental data 106 that meet or exceed at least one validity threshold. The second subset 109 comprises the instances of supplemental data 106 that do not meet or exceed the at least one validity threshold. If the validator 102 determines an instance of supplemental data 106 meets or exceeds at least one validity threshold by successfully identifying the outlier in one or more permutations, the instance of supplemental data 106 is added to the first subset 108 of the interim data 107. Once a threshold number of instances of supplemental data 106 is reached, the validator 102 selects the first subset 108 of the interim data 107 as validated training data 105 for the task of CTA 409. Once a threshold number of instances of validated training data 105 are selected, the validated training data 105 is used to iteratively fine-tune the generator 101 and the validator 102. Iteratively fine-tuning the generator 101 comprises increasing or decreasing one or more weight parameters 110 of the generator 101 that determine how the generator 101 processes the table data 103 and produces the generated training data 104. Iteratively fine-tuning the validator 102 comprises increasing or decreasing one or more weight parameters 110 of the validator 102 that determine how the validator 102 processes the generated training data 104 and produces the validated training data 105. Specifically, the system 100 compares the generated training data 104 to the validated training data 105 to compute at least one loss value 112 for the generator 101, quantifying at least one error metric 113 between the generated training data 104 and the validated training data 105, such as a number of mismatched tokens in a generated piece of code, a count of incorrect modifications in a table, or a discrepancy in numerical values. The system 100 then compares the validator's evaluation of the generated training data 104, using the interim data 107, to ground truth labels 116, which may be derived from predefined validation criteria or the validated training data 105, to compute at least one loss value 114 for the validator 102, quantifying at least one error metric 115 between the interim data 107 and the ground truth labels 116, such as a number of misclassified errors in a table, a count of false positives and false negatives in entity matching, or the accuracy of determining whether a generated piece of code meets predefined validation criteria. Through gradient descent, each model iteratively adjusts one or more weight parameters 110 during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

Each subsequent iteration of training repeats the operations of the first iteration using subsequent instances of table data 103′ sampled from the table corpus 111. Subsequent instances of table data 103′ differ from instances of table data 103 that were sampled from the table corpus 111 in previous iterations. The subsequent instances of table data 103′ are used as an input to the first model 101 for generating a subsequent iteration of generated training data 104′. The subsequent iteration of generated training data 104′ is used as an input to the second model 102 for generating a subsequent iteration of validated training data 105′. Each subsequent iteration of validated training data 105′ is used to iteratively increase or decrease one or more weight parameters 110 of the first model 101 and one or more weight parameters 110 of the second model 102. Each iteration of training produces a nth iteration of validated training data 105′ that is used to increase the accuracy and efficiency of the models and improve their performance on the task of CTA 409, thereby producing a trained first model 101 and a trained second model 102.

A further embodiment of the system 100 may employ similar techniques to those described above to also train models for the classification task of schema matching 407.

Additional embodiments of the system 100 may be configured to train models for table-related generative tasks 402. Generative tasks 402 are a type of machine learning task where a model must produce, or “generate,” some form of additional information in addition to generating a “yes” or “no” response.

In one embodiment, the system 100 can be configured to train models for the generative task of NL2SQL 406. The goal of an NL2SQL model is to generate at least one short snippet of code in response to a natural language prompt (“NLP”). In addition to SQL, the desired code can be output in the form of an Excel formula, some other type of Domain-Specific Language (“DSL”), or any coding language desired by the user so when that piece of code is executed on a table, the model provides the answer based on the natural language provided by the user.

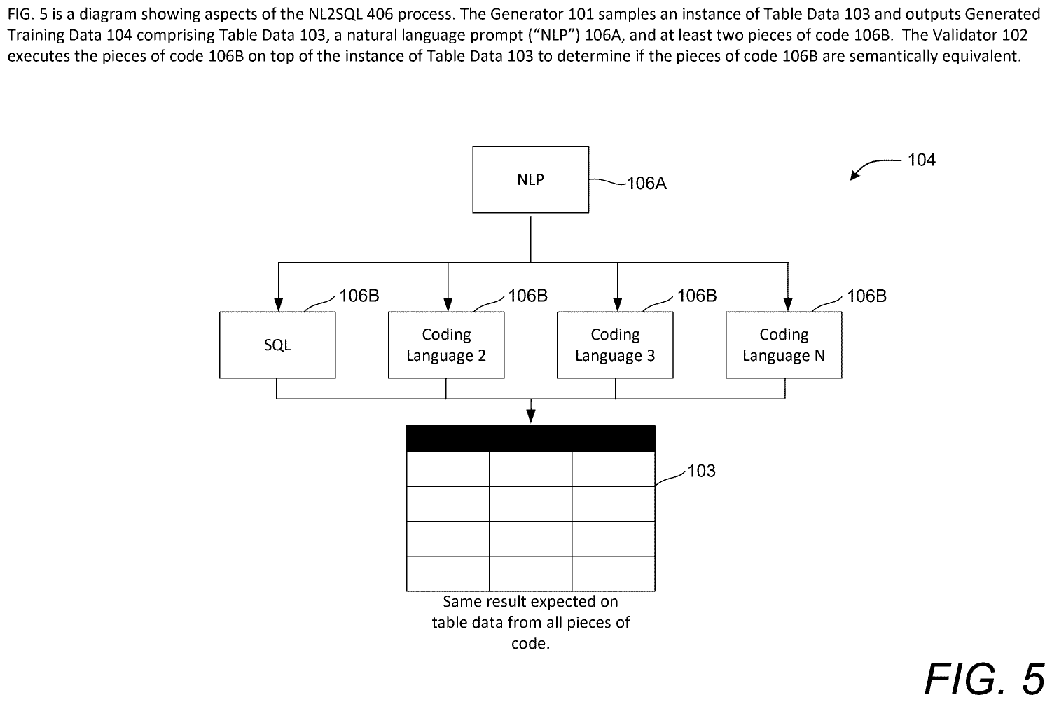

To train the models for the generative task of NL2SQL 406, the system 100 uses the generator-validator framework shown in FIGS. 1-3 to concurrently train both a generator 101 for generating training data 104 and a validator 102 for validating the generated training data 104. The system 100 begins a first iteration of training by feeding instances of table data 103 that are sampled from a corpus of tables 111 into the generator 101, which begins as an untrained language model, such as GPT 3 or GPT 4. In response to receiving the instances of table data 103, the generator 101 performs at least one generator function to produce generated training data 104 for the task of NL2SQL 406. The generated training data 104 comprises both the instances of table data 103 and corresponding instances of supplemental data 106 that characterize modifications and/or additions to the rows and columns of the table data 103 produced by the generator function. Specifically, the generator 101 produces generated training data 104 by sampling each instance of table data 103 and generating a corresponding instance of supplemental data 106 for at least one row or column in each instance of table data 103. As shown in FIG. 5, each instance of generated training data 104 for NL2SQL 406 comprises an instance of table data 103 and an instance of supplemental data 106. Each instance of supplemental data 106 further comprises a natural language prompt 106A that corresponds to the instance of table data 103 in the instance of generated training data 104 and at least two pieces of code 106B that the generator 101 produces based on the natural language prompt 106A. The first piece of code is generated in a first coding language, such as SQL, and each additional piece of code is generated in a different coding language, such as a second piece of code generated in Python. SQL and Python are used herein as examples, but as mentioned above, the pieces of code can be output in any coding language or format that is known in the art and specified by the user.

Next, the generated training data 104 is fed to the validator 102, which also begins as an untrained language model. In response to receiving the generated training data 104, the validator 102 performs at least one validation function to leverage the fact that the same natural language or piece of logic can be embodied in different types of coding languages. Specifically, the validator 102 performs at least one validation function to produce interim data 107 and determine which instances of supplemental data 106 meet or exceed at least one validity threshold. The interim data 107 comprises a first subset 108 of the supplemental data 106 and a second subset 109 of the supplemental data 106. The first subset 108 comprises the instances of supplemental data 106 that meet or exceed at least one validity threshold. The second subset 109 comprises the instances of supplemental data 106 that do not meet or exceed the at least one validity threshold. In the case of NL2SQL 406, the validator 102 determines an instance of supplemental data 106 meets or exceeds at least one validity threshold by executing the piece of SQL code and the piece of Python code on top of the sampled instance of table data 103, or a subset thereof, a threshold number of times. If the same result is consistently achieved by executing both pieces of code on the same permutations or subsets of the sampled instance of table data 103, the two pieces of code 106B are likely to be semantically equivalent and truthfully translate the meaning from the natural language prompt 106A. This semantic equivalency indicates the given instance of supplemental data 106 is a good quality training example. If the validator 102 determines an instance of supplemental data 106 meets or exceeds the at least one validity threshold by achieving the same result from the two pieces of code 106B executing on top of the instance of table data 103, the instance of supplemental data 106 is added to the first subset 108 of the interim data 107. It should be noted that in the embodiments described herein, the validator 102 may alternatively add only the natural language prompt 106A and a single piece of code 106B to the first subset 108 depending on the coding language of interest to the user and the desired specificity of the models being trained. Once a threshold number of instances of supplemental data 106 is reached, the validator 102 selects the first subset 108 of the interim data 107 as validated training data 105 for the task of NL2SQL 406. Once a threshold number of instances of validated training data 105 are selected, the validated training data 105 is used to iteratively fine-tune the generator 101 and the validator 102. Iteratively fine-tuning the generator 101 comprises increasing or decreasing one or more weight parameters 110 of the generator 101 that determine how the generator 101 processes the table data 103 and produces the generated training data 104. Iteratively fine-tuning the validator 102 comprises increasing or decreasing one or more weight parameters 110 of the validator 102 that determine how the validator 102 processes the generated training data 104 and produces the validated training data 105. Specifically, the system 100 compares the generated training data 104 to the validated training data 105 to compute at least one loss value 112 for the generator 101, quantifying at least one error metric 113 between the generated training data 104 and the validated training data 105, such as a number of mismatched tokens in a generated piece of code, a count of incorrect modifications in a table, or a discrepancy in numerical values. The system 100 then compares the validator's evaluation of the generated training data 104, using the interim data 107, to ground truth labels 116, which may be derived from predefined validation criteria or the validated training data 105, to compute at least one loss value 114 for the validator 102, quantifying at least one error metric 115 between the interim data 107 and the ground truth labels 116, such as a number of misclassified errors in a table, a count of false positives and false negatives in entity matching, or the accuracy of determining whether a generated piece of code meets predefined validation criteria. Through gradient descent, each model iteratively adjusts one or more weight parameters 110 during the fine-tuning process, using computed gradients to minimize each model's respective loss value(s), which reduces each model's respective error metric(s) in future iterations of the training process and improves performance on associated tasks, thereby enhancing the generation and validation of training data in subsequent iterations of training.

Each subsequent iteration of training repeats the operations of the first iteration using subsequent instances of table data 103′ sampled from the table corpus 111. Subsequent instances of table data 103′ differ from instances of table data 103 that were sampled from the table corpus 111 in previous iterations. The subsequent instances of table data 103′ are used as an input to the first model 101 for generating a subsequent iteration of generated training data 104′. The subsequent iteration of generated training data 104′ is used as an input to the second model 102 for generating a subsequent iteration of validated training data 105′. Each subsequent iteration of validated training data 105′ is used to iteratively increase or decrease one or more weight parameters 110 of the first model 101 and one or more weight parameters 110 of the second model 102. Each iteration of training produces a nth iteration of validated training data 105′ that is used to increase the accuracy and efficiency of the models and improve their performance on the task of NL2SQL 406, thereby producing a trained first model 101 and a trained second model 102.

Additional embodiments of the system 100 may employ similar techniques to those described for NL2SQL 406 to also train models for the generative tasks 402 of Table QA 404 and NL2Pandas 408.

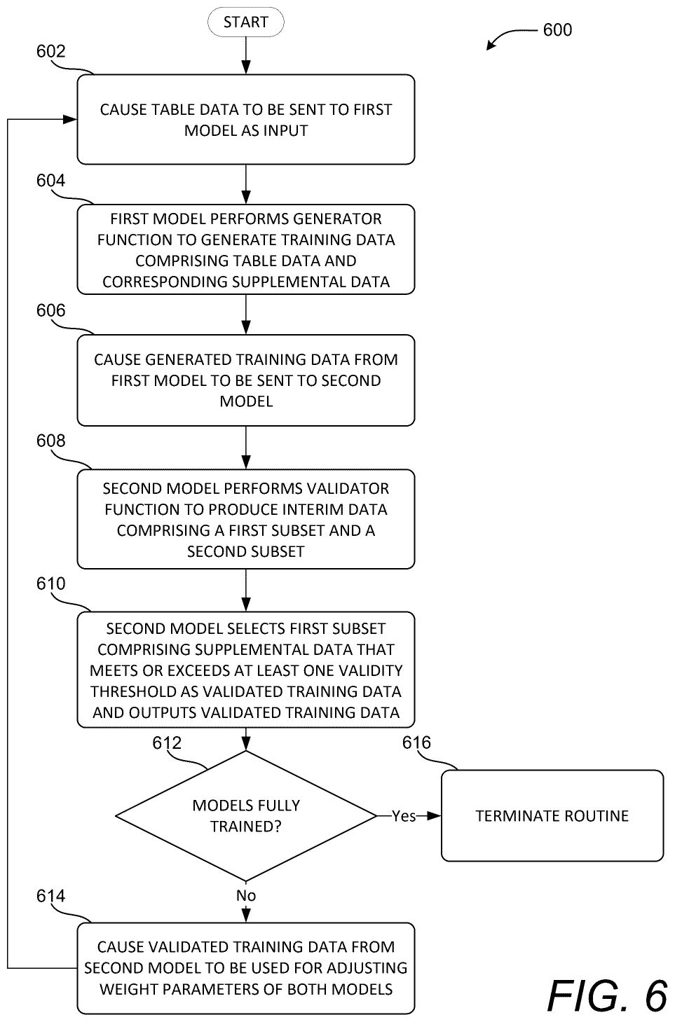

FIG. 6 is a flow diagram illustrating aspects of routine 600 for using table data 103 to train large language models, according to one or more embodiments presented herein. The routine begins at operation 602, where the system 100 causes instances of table data 103 to be sent to a first model 101 as an input. The routine then proceeds to operation 604, where the first model 101 performs a generator function to generate training data comprising instances of table data 103 and corresponding instances of supplemental data 106. Next, the routine proceeds to operation 606, where the system 100 causes the training data generated by the first model 101 to be sent to the second model 102. The routine then proceeds to operation 608, where the second model 102 performs a validator function to produce interim data 107 comprising a first subset 108 of the instances of supplemental data 106 that meet or exceed at least one validity threshold and a second subset 109 of the instances of supplemental data 106 that do not meet or exceed at least one validity threshold. Next, the routine proceeds to operation 610, where the second model 102 selects the first subset 108 comprising the instances of supplemental data 106 that meet or exceed at least one validity threshold as validated training data 105 and outputs the validated training data 105. The routine then proceeds to operation 612, where the system 100 determines if the models are fully trained. If the models are fully trained, the routine proceeds from operation 612 to operation 616, where the routine for training the large language models terminates. If the models are not fully trained, the routine proceeds from operation 612 to operation 614, where the system 100 causes the validated training data 105 to be used to fine-tune the first model 101 and the second model 102 by adjusting one or more weight parameters 110 of the first model 101 and one or more weight parameters 110 of the second model 102. The routine then begins again from operation 602, where subsequent instances of table data 103′ are used as an input to the first model 101. It should be noted that the system 100 causing the movement of data during the routine can include the system 100 sending and/or receiving data itself, the system 100 directing a model or some other module associated with the system 100 to send and/or receive data, or any combination thereof that facilitates the movement of data during the routine.

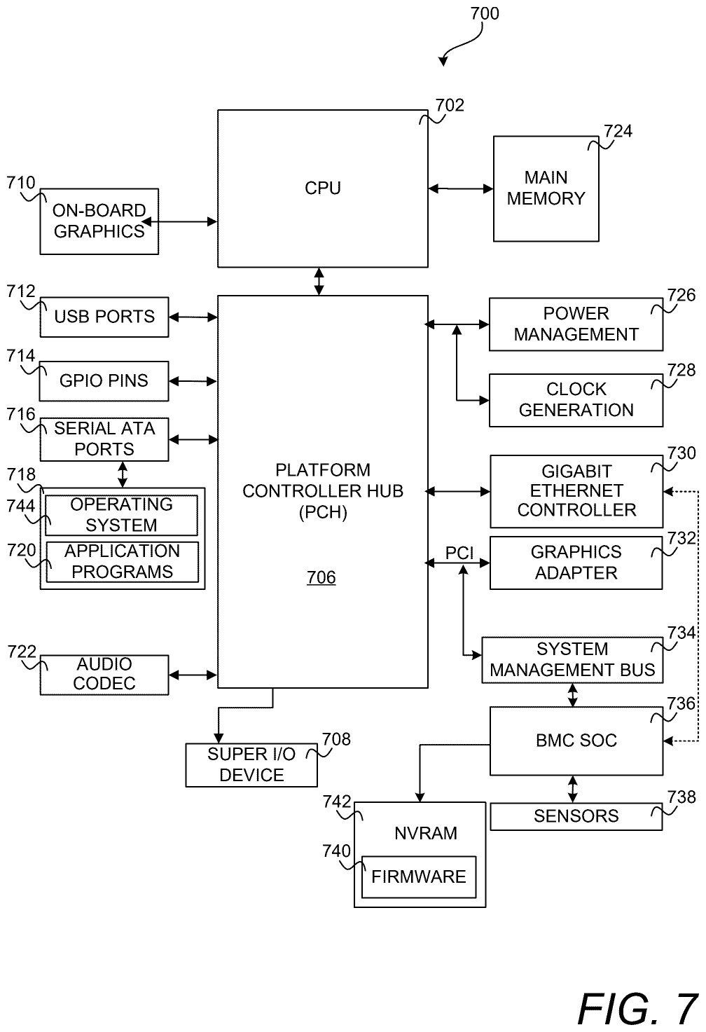

FIG. 7 and the following discussion are intended to provide a brief, general description of a suitable computing environment in which the configurations described herein can be implemented. In addition to the components shown in previous figures, any of the configurations described herein can also include some or all of the components shown in FIG. 7. While the technical details are presented herein in the general context of program modules that execute in conjunction with the execution of an operating system, those skilled in the art will recognize that the configurations can also be implemented in combination with other program modules.

Generally, program modules include routines, programs, components, data structures, and other types of structures that perform particular tasks or implement particular abstract data types. Moreover, those skilled in the art will appreciate that the configurations described herein can be practiced with other computer system configurations, including hand-held devices, multiprocessor systems, microprocessor-based or programmable consumer electronics, minicomputers, mainframe computers, and the like. The configurations described herein can also be practiced in distributed computing environments where tasks are performed by remote processing devices that are linked through a communications network. In a distributed computing environment, program modules can be located in both local and remote memory storage devices.

In particular, FIG. 7 shows an illustrative computer architecture for a computer 700 that can be utilized as the system 100 in the implementations described herein. The illustrative computer architecture shown in FIG. 7 includes a baseboard, or “motherboard”, which is a printed circuit board to which a multitude of components or devices can be connected by way of a system bus or other electrical communication path.

In one illustrative configuration, a central processing unit (“CPU”) 702 operates in conjunction with a Platform Controller Hub (“PCH”) 706. The CPU 702 is a central processor that performs arithmetic and logical operations necessary for the operation of the computer 700. The computer 700 can include a multitude of CPUs 702. Each CPU 702 might include multiple processing cores.

The CPU 702 provides an interface to a random access memory (“RAM”) used as the main memory 724 in the computing device 700 and, possibly, to an on-board graphics adapter 710. The PCH 706 provides an interface between the CPU 702 and the remainder of the computing device 700.

The PCH 706 can also be responsible for controlling many of the input/output functions of the computer 700. In particular, the PCH 706 can provide one or more universal serial bus (“USB”) ports 712, an audio codec 722, a Gigabit Ethernet Controller 730, and one or more general purpose input/output (“GPIO”) pins 714. The USB ports 712 can include USB 2.0 ports, USB 3.0 ports and USB 3.1 ports among other USB ports. The audio codec 722 can include Intel High Definition Audio, Audio Codec '97 (“AC'97”) and Dolby TrueHD among others.

The PCH 706 can also include functionality for providing networking functionality through a Gigabit Ethernet Controller 730. The Gigabit Ethernet Controller 730 is capable of connecting the computer 700 to another computer via a network. Connections which can be made by the Gigabit Ethernet Controller 730 can include LAN or WAN connections. LAN and WAN networking environments are commonplace in offices, enterprise-wide computer networks, intranets, and the Internet.

The PCH 706 can also provide a bus for interfacing peripheral card devices such as a graphics adapter 732. In one configuration, the bus comprises a PCI bus. The PCI bus can include a Peripheral Component Interconnect (“PCI”) bus, a Peripheral Component Interconnect eXtended (“PCI-X”) bus and a Peripheral Component Interconnect Express (“PCIe”) bus among others.

The PCH 706 can also provide a system management bus 734 for use in managing the various components of the computer 700. Additional details regarding the operation of the system management bus 734 and its connected components are provided below. Power management circuitry 726 and clock generation circuitry 728 can also be utilized during the operation of the PCH 706.

The PCH 706 is also configured to provide one or more interfaces for connecting mass storage devices to the computer 700. For instance, according to one configuration, the PCH 706 includes a serial advanced technology attachment (“SATA”) adapter for providing one or more serial ATA ports 716. The serial ATA ports 716 can be connected to one or more mass storage devices storing an OS, such as OS 744 and application programs 720, such as a SATA disk drive 718. As known to those skilled in the art, an OS 744 comprises a set of programs that control operations of a computer and allocation of resources. An application program is software that runs on top of the operating system 744, or other runtime environment, and uses computer resources to perform application specific tasks desired by the user.

According to one configuration, the OS 744 comprises the LINUX operating system. According to another configuration, the OS 744 comprises the WINDOWS operating system from MICROSOFT CORPORATION. According to another configuration, the OS 744 comprises the UNIX operating system or one of its variants. It should be appreciated that other operating systems can also be utilized.

The mass storage devices connected to the PCH 706, and their associated computer-readable storage media, provide non-volatile storage for the computer 700. Although the description of computer-readable storage media contained herein refers to a mass storage device, such as a hard disk or CD-ROM drive, it should be appreciated by those skilled in the art that computer-readable storage media can be any available media that can be accessed by the computer 700.

As utilized herein, data processing unit(s), such as 702, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media may store instructions executable by data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in the system 100, while in some examples one or more of a CPU, GPU, and/or accelerator is external to the system 100.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

A low pin count (“LPC”) interface can also be provided by the PCH 706 for connecting a Super I/O device 708. The Super I/O device 708 is responsible for providing a number of input/output ports, including a keyboard port, a mouse port, a serial interface, a parallel port, and other types of input/output ports.

It should be appreciated that the program modules disclosed herein can include software instructions that, when loaded into the CPU 702 and executed, transform a general-purpose computer 700 into a special-purpose computer 700 customized to facilitate all, or part of, the operations disclosed herein. As detailed throughout this description, the program modules can provide various tools or techniques by which the computer 700 can participate within the overall systems or operating environments using the components, logic flows, and/or data structures discussed herein.

The CPU 702 can be constructed from any number of transistors or other circuit elements, which can individually or collectively assume any number of states. More specifically, the CPU 702 can operate as a state machine or finite-state machine. Such a machine can be transformed to a second machine, or a specific machine, by loading executable instructions contained within the program modules. These computer-executable instructions can transform the CPU 702 by specifying how the CPU 702 transitions between states, thereby transforming the transistors or other circuit elements constituting the CPU 702 from a first machine to a second machine, wherein the second machine can be specifically configured to perform the operations disclosed herein. The states of either machine can also be transformed by receiving input from one or more user input devices, network interfaces (such as the Gigabit Ethernet Controller 730), other peripherals, other interfaces, or one or more users or other actors. Either machine can also transform states, or various physical characteristics of various output devices such as printers, speakers, video displays, or otherwise.

Encoding the program modules can also transform the physical structure of the storage media. The specific transformation of physical structure can depend on various factors, in different implementations of this description. Examples of such factors can include, but are not limited to the technology used to implement the storage media, whether the storage media are characterized as primary or secondary storage, and the like. For example, if the storage media are implemented as semiconductor-based memory, the program modules can transform the physical state of the semiconductor main memory and/or NVRAM. For example, the software can transform the state of transistors, capacitors, or other discrete circuit elements constituting the semiconductor memory.

As another example, the storage media can be implemented using magnetic or optical technology such as hard drives or optical drives. In such implementations, the program modules can transform the physical state of magnetic or optical media, when the software is encoded therein. These transformations can include altering the magnetic characteristics of particular locations within given magnetic media. These transformations can also include altering the physical features or characteristics of particular locations within given optical media to change the optical characteristics of those locations. It should be appreciated that various other transformations of physical media are possible without departing from the scope and spirit of the present description.

As described above, the PCH 706 can include a system management bus 734. As discussed above, when utilized to implement the system 100, the system management bus 734 can include a BMC SOC 736. As discussed above, the BMC SOC 736 is a microcontroller that includes functionality for monitoring aspects of the operation of the computer 700.

It should be appreciated that the functionality provided by the computer 700 can be provided by other types of computing devices, including hand-held computers, smartphones, gaming systems, set top boxes, tablet computers, embedded computer systems, personal digital assistants, and other types of computing devices known to those skilled in the art. It is also contemplated that the computer 700 might not include all the components shown in FIG. 7, can include other components that are not explicitly shown in FIG. 7, or might utilize an architecture completely different than that shown in FIG. 7.

Although the subject matter presented herein has been described in language specific to computer structural features, methodological acts, and computer readable media, it is to be understood that the present invention is not necessarily limited to the specific features, acts, or media described herein. Rather, the specific features, acts and mediums are disclosed as example forms.

The subject matter described above is provided by way of illustration only and should not be construed as limiting. Various modifications and changes can be made to the subject matter described herein without following the example configurations and applications illustrated and described, and without departing from the true spirit and scope of the present invention.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computer-implemented method for execution on a system, utilizing models and instances of table data to train large language models, the method comprising:
sending instances of table data to a first model, the first model configured to receive the instances of table data and, in response, perform a generator function to produce generated training data, wherein the generated training data comprises the instances of table data and corresponding instances of supplemental data characterizing modifications or additions to the rows and columns of the instances of table data produced by the generator function;
receiving the generated training data from the first model;
sending the generated training data to the second model, the second model configured to:
receive the generated training data and, in response, perform a validator function to evaluate the generated training data and produce interim data, wherein the interim data comprises a first subset of the supplemental data and a second subset of the supplemental data, the first subset comprising instances of supplemental data that meet or exceed at least one validity threshold, and the second subset comprising instances of supplemental data that do not meet or exceed the at least one validity threshold; and
select the first subset having the instances of supplemental data that meet or exceed the at least one validity threshold from the interim data as validated training data; and
receiving the validated training data from the second model;
using the validated training data to fine-tune the first model, wherein fine-tuning the first model comprises increasing or decreasing one or more weight parameters of the first model that determine how the first model processes the table data and produces the generated training data; and
using the validated training data to fine-tune the second model, wherein fine-tuning the second model comprises increasing or decreasing one or more weight parameters of the second model that determine how the second model processes the generated training data and produces the validated training data, thereby producing a trained first model and a trained second model.

2. The method of claim 1, wherein the validator function performed by the second model comprises sampling the generated training data and detecting linguistic errors in at least one row or column of the generated training data.

3. The method of claim 1, wherein the validator function performed by the second model comprises sampling the generated training data and detecting fuzzy duplicates in at least one row or column of the generated training data.

4. The method of claim 1, wherein the validator function performed by the second model comprises performing a semantic analysis of the generated training data and identifying at least one outlier column header based on the semantic analysis.

5. The method of claim 1, wherein the generator function performed by the first model comprises sampling each of the instances of table data, and wherein the corresponding instances of supplemental data each comprise a natural language prompt that corresponds to one of the instances of table data and at least two pieces of code in different coding languages that correspond to the natural language prompt.

6. The method of claim 5, wherein the validator function performed by the second model comprises executing the at least two pieces of code on top of at least a portion of the one of the instances of table data that corresponds to the natural language prompt and analyzing the results to determine if the at least two pieces of code are semantically equivalent.

7. The method of claim 1, wherein using the validated training data to fine-tune the models further comprises using gradient descent to minimize a first loss value for the first model, the first loss value quantifying a first error metric between the generated training data and the validated training data, and a second loss value for the second model, the second loss value quantifying a second error metric between the interim data and ground truth labels, wherein the ground truth labels are derived from the validated training data.

8. A computing device, comprising:
one or more processing units; and
a computer readable storage medium having encoded thereon computer-executable instructions to cause the one or more processing units to perform a method comprising:
sending instances of table data to a first model, the first model configured to receive the instances of table data and, in response, perform a generator function to produce generated training data, wherein the generated training data comprises the instances of table data and corresponding instances of supplemental data characterizing modifications or additions to the rows and columns of the instances of table data produced by the generator function;
receiving the generated training data from the first model;
sending the generated training data to the second model, the second model configured to:
receive the generated training data and, in response, perform a validator function to evaluate the generated training data and produce interim data, wherein the interim data comprises a first subset of the supplemental data and a second subset of the supplemental data, the first subset comprising instances of supplemental data that meet or exceed at least one validity threshold, and the second subset comprising instances of supplemental data that do not meet or exceed the at least one validity threshold; and
select the first subset having the instances of supplemental data that meet or exceed the at least one validity threshold from the interim data as validated training data; and
receiving the validated training data from the second model;
using the validated training data to fine-tune the first model, wherein fine-tuning the first model comprises increasing or decreasing one or more weight parameters of the first model that determine how the first model processes the table data and produces the generated training data; and
using the validated training data to fine-tune the second model, wherein fine-tuning the second model comprises increasing or decreasing one or more weight parameters of the second model that determine how the second model processes the generated training data and produces the validated training data, thereby producing a trained first model and a trained second model.

9. The system of claim 8, wherein the validator function performed by the second model comprises sampling the generated training data and detecting linguistic errors in at least one row or column of the generated training data.

10. The system of claim 8, wherein the validator function performed by the second model comprises sampling the generated training data and detecting fuzzy duplicates in at least one row or column of the generated training data.

11. The system of claim 8, wherein the validator function performed by the second model comprises performing a semantic analysis of the generated training data and identifying at least one outlier column header based on the semantic analysis.

12. The system of claim 8, wherein the generator function performed by the first model comprises sampling each of the instances of table data, and wherein the corresponding instances of supplemental data each comprise a natural language prompt that corresponds to one of the instances of table data and at least two pieces of code in different coding languages that correspond to the natural language prompt.

13. The system of claim 12, wherein the validator function performed by the second model comprises executing the at least two pieces of code on top of at least a portion of the one of the instances of table data that corresponds to the natural language prompt and analyzing the results to determine if the at least two pieces of code are semantically equivalent.

14. The system of claim 8, wherein using the validated training data to fine-tune the models further comprises using gradient descent to minimize a first loss value for the first model, the first loss value quantifying a first error metric between the generated training data and the validated training data, and a second loss value for the second model, the second loss value quantifying a second error metric between the interim data and ground truth labels, wherein the ground truth labels are derived from the validated training data.

15. A computer-readable storage medium having encoded thereon computer-executable instructions to cause one or more processing units of a system to perform a method comprising:
sending instances of table data to a first model, the first model configured to receive the instances of table data and, in response, perform a generator function to produce generated training data, wherein the generated training data comprises the instances of table data and corresponding instances of supplemental data characterizing modifications or additions to the rows and columns of the instances of table data produced by the generator function;
receiving the generated training data from the first model;
sending the generated training data to the second model, the second model configured to:
receive the generated training data and, in response, perform a validator function to evaluate the generated training data and produce interim data, wherein the interim data comprises a first subset of the supplemental data and a second subset of the supplemental data, the first subset comprising instances of supplemental data that meet or exceed at least one validity threshold, and the second subset comprising instances of supplemental data that do not meet or exceed the at least one validity threshold; and
select the first subset having the instances of supplemental data that meet or exceed the at least one validity threshold from the interim data as validated training data; and
receiving the validated training data from the second model;
using the validated training data to fine-tune the first model, wherein fine-tuning the first model comprises increasing or decreasing one or more weight parameters of the first model that determine how the first model processes the table data and produces the generated training data; and
using the validated training data to fine-tune the second model, wherein fine-tuning the second model comprises increasing or decreasing one or more weight parameters of the second model that determine how the second model processes the generated training data and produces the validated training data, thereby producing a trained first model and a trained second model.

16. The computer-readable storage medium of claim 15, wherein the validator function performed by the second model comprises sampling the generated training data and detecting linguistic errors in at least one row or column of the generated training data.

17. The computer-readable storage medium of claim 15, wherein the validator function performed by the second model comprises sampling the generated training data and detecting fuzzy duplicates in at least one row or column of the generated training data.

18. The computer-readable storage medium of claim 15, wherein the validator function performed by the second model comprises performing a semantic analysis of the generated training data and identifying at least one outlier column header based on the semantic analysis.

19. The computer-readable storage medium of claim 15, wherein the generator function performed by the first model comprises sampling each of the instances of table data, and wherein the corresponding instances of supplemental data each comprise a natural language prompt that corresponds to one of the instances of table data and at least two pieces of code in different coding languages that correspond to the natural language prompt.

20. The computer-readable storage medium of claim 15, wherein using the validated training data to fine-tune the models further comprises using gradient descent to minimize a first loss value for the first model, the first loss value quantifying a first error metric between the generated training data and the validated training data, and a second loss value for the second model, the second loss value quantifying a second error metric between the interim data and ground truth labels, wherein the ground truth labels are derived from the validated training data.
